(19) United States
(12) Patent Application Publication
(10) Pub. No.: US 2016/0019846 A1
(43) Pub. Date: Jan. 21, 2016

(54) DISPLAY APPARATUS

(71) Applicant: SAMSUNG DISPLAY CO., LTD., Yongin-City (KR)

(72) Inventors: Heendol Kim, Yongin-si (KR); Jai-Hyun Koh, Hwaseong-si (KR); Jinpil Kim, Suwon-si (KR); Seokyun Son, Yongin-si (KR); Kuk-Hwan Ahn, Hwaseong-si (KR)

(21) Appl. No.: 14/790,926

(22) Filed: Jul. 2, 2015

(30) Foreign Application Priority Data
Jul. 21, 2014 (KR) 10-2014-0091974

(51) Int. Cl. G09G 3/34

(52) U.S. Cl. CPC G09G 3/3406; G09G 2320/0233

(57) ABSTRACT

A display apparatus includes: a display panel including a first display area and a second display area; a first control driver configured to receive first data signals, control the display panel to display images on the first display area, and generate a first histogram corresponding to the first data signals; a second control driver configured to receive second data signals, control the display panel to display images on the second display area, and generate a second histogram corresponding to the second data signals; and a backlight unit configured to supply light to the display panel. The first control driver is further configured to receive the second histogram from the second control driver and generate a backlight control signal for controlling luminance of the backlight unit based on the first and second histograms.

### CROSS-REFERENCE TO RELATED APPLICATIONS

This application claims priority to and the benefit of Korean Patent Application No. 10-2014-0091974, filed on Jul. 21, 2014 in the Korean Intellectual Property Office, the entire content of which is herein incorporated by reference.

### BACKGROUND

1. Field

Aspects of embodiments of the present invention relate to a display apparatus.

2. Description of Related Art

Generally, a display apparatus includes a display panel for displaying an image and a driving circuit for driving the display panel. The driving circuit may include a timing controller, a data driver, and a gate driver. The timing controller may be installed on an independent substrate and provide image signals and control signals used in driving the data driver and the gate driver.

By using timing controller embedded driver (TED) techniques, the timing controller and the data driver may be integrated in a single chip. However, due to factors such as pitch (distance) between pads for the data driver and limited circuit area, it is difficult to integrate the timing controller and the data driver in a single chip.

The display apparatus may express color using three primary colors, such as red, green, and blue. For example, the display panel may include sub-pixels Rx, Gx, and Bx respectively corresponding to red, green, and blue. Further, to increase luminance of displayed images, the display panel may also include white sub-pixels Wx. For example, a pentile technique may be used to arrange two pixels using four sub-pixels Rx, Gx, Bx, and Wx, versus an alternative arrangement such as six sub-pixels Rx, Gx, Bx, Rx, Gx, and Bx.

A display device for implementing such a pentile technique may include a rendering module that compensates for resolution degradation due to a decrease in the number of sub-pixels. The rendering module may transform red, green, and blue image signals, which are supplied from an external device, into red, green, blue, and white data signals. The rendering module may adjust the luminance of a backlight unit, thereby improving luminance of an image.

### SUMMARY

Aspects of embodiments of the present invention are directed to providing a display apparatus including at least two control drivers. Further aspects are directed to providing a display apparatus capable of transmitting or receiving signals between at least two control drivers. However, the aspects of the present invention are not limited to the above disclosure; other aspects may become apparent to those of ordinary skill in the art based on the following written description and corresponding drawings.

In an embodiment of the present invention, a display apparatus is provided. The display apparatus includes: a display panel including a first display area and a second display area; a first control driver configured to receive first data signals, control the display panel to display images on the first display area, and generate a first histogram corresponding to the first data signals; a second control driver configured to receive second data signals, control the display panel to display images on the second display area, and generate a second histogram corresponding to the second data signals; and a backlight unit configured to supply light to the display panel. The first control driver is further configured to receive the second histogram from the second control driver and generate a backlight control signal for controlling luminance of the backlight unit based on the first and second histograms.

The first and second data signals may each include first color data, second color data, and third color data.

The first control driver may include: a first controller configured to generate first output data signals based on the first data signals, a first data enable signal, and the second histogram, and to generate the backlight control signal; a first data driver configured to drive the first display area of the display panel using the first output data signals; and a first transmitting and receiving control unit configured to control a signal exchange between the first controller and the second control driver.

The first controller may include: a first rendering module configured to generate first middle data signals including the first color data, the second color data, the third color data, and a fourth color data based on the first data signals; a first timing control unit configured to control a timing of the first data enable signal to output a first enable signal; and a first backlight control unit configured to generate a first scaler signal and the backlight control signal based on the first enable signal, the first middle data signals, and the second histogram. The first rendering module may be further configured to generate the first output data signals based on the first data signals and the first scaler signal.

The first backlight control unit may include: a first data input unit configured to output first middle input data signals by selecting a portion of the first middle data signals based on the first enable signal; a first histogram generation unit configured to generate the first histogram corresponding to the first middle input data signals; a backlight luminance calculation unit configured to generate the backlight control signal based on the first histogram and the second histogram from the second control driver; and a first data correction unit configured to generate the first scaler signal corresponding to the backlight control signal.

The first transmitting and receiving control unit may be further configured to supply the first scaler signal to the second control driver.

The first transmitting and receiving control unit may be further configured to receive the second histogram from the second control driver when a histogram ready signal and a histogram transmission signal are received from the second control driver.

The first timing control unit may include: a delay unit configured to delay the first data enable signal for a first delay period; and a logic circuit configured to perform a logical operation with respect to the first data enable signal and the delayed first data enable signal outputted from the delay unit to output the first enable signal.

The second control driver may include: a second controller configured to generate second output data signals based on the second data signals, a second data enable signal, and the first scaler signal; a second data driver configured to drive the second display area of the display panel using the second output data signals; and a second transmitting and receiving control unit configured to control a signal exchange between the second controller and the first control driver.

The second controller may include: a second rendering module configured to generate second middle data signals including the first color data, the second color data, the third color data, and the fourth color data based on the second data signals; a second timing control unit configured to control a timing of the second data enable signal to output a second enable signal; and a second backlight control unit configured to generate a second scaler signal based on the first scaler signal from the first control driver. The second rendering module may be further configured to generate the second output data signals based on the second data signals and the second scaler signal.

The second timing control unit may include: a first delay unit configured to output a first delay signal by delaying the second data enable signal for a second delay period; a second delay unit configured to output a second delay signal by delaying the first delay signal for a third delay period; and a logic circuit configured to perform a logical operation with respect to the first delay signal and the second delay signal to output the second enable signal.

The second backlight control unit may include: a second data input unit configured to output second middle input data signals by selecting a portion of the second middle data signals based on the second enable signal; a second histogram generation unit configured to generate the second histogram corresponding to the second middle input data signals; and a second data correction unit configured to generate the second scaler signal based on the first scaler signal from the first control driver.

The second transmitting and receiving control unit may be further configured to receive the first scaler signal from the first control driver when a scaler ready signal and a scaler transmission signal are received from the first control driver.

The first rendering module may include: an input gamma adjustment unit configured to adjust a gamma characteristic of the first data signals; a mapping unit configured to map the first data signals to the first middle data signals; a rendering unit configured to output first rendering signals by making the first middle data signals pass through a rendering filter; and an output gamma adjustment unit configured to adjust a gamma characteristic of the first rendering signals to output the first output data signals.

The display panel may include first and second pixels. The first pixel may include first and second sub pixels respectively corresponding to the first color data and the second color data. The second pixel may include third and fourth sub pixels respectively corresponding to the third color data and the fourth color data.

The first control driver may be a master control driver and the second control driver may be a slave control driver.

An example display device according to an embodiment of the present invention may include at least two control drivers and may transmit and receive signals (such as histogram data) between the at least two control drivers. As such, image quality of a display panel of the display device may be enhanced due to factors such as sharing and rendering histogram data between the at least two control drivers.

### BRIEF DESCRIPTION OF THE FIGURES

The above and other aspects and features of the present invention will become apparent from the following description with reference to the accompanying figures, wherein like reference numerals refer to like parts throughout the various figures unless otherwise specified, and wherein:

FIG. 1 is a schematic diagram illustrating a display apparatus according to an embodiment of the present invention;

FIG. 2 is a schematic diagram illustrating an example array of pixels included in a display panel shown in FIG. 1 according to an embodiment of the present invention;

FIG. 3 is a block diagram illustrating an example configuration of a first control driver shown in FIG. 1 according to an embodiment of the present invention;

FIG. 4 is a circuit diagram illustrating an example configuration of a timing control unit shown in FIG. 3 according to an embodiment of the present invention;

FIG. 5 is a block diagram illustrating an example configuration of a backlight control unit shown in FIG. 3 according to an embodiment of the present invention;

FIG. 6 is a timing diagram illustrating an example operation of the timing control unit shown in FIG. 4 and the backlight control unit shown in FIG. 5 according to an embodiment of the present invention;

FIGS. 7A to 7C are schematic diagrams illustrating example mapping and rendering processes of a mapping unit and a sub pixel rendering unit shown in FIG. 3 according to embodiments of the present invention;

FIG. 8 is a block diagram illustrating an example configuration of a second control driver shown in FIG. 1 according to an embodiment of the present invention;

FIG. 9 is a circuit diagram illustrating an example configuration of a timing control unit shown in FIG. 8 according to an embodiment of the present invention;

FIG. 10 is a block diagram illustrating an example configuration of a backlight control unit shown in FIG. 8 according to an embodiment of the present invention;

FIG. 11 is a timing diagram illustrating an example operation of the timing control unit shown in FIG. 9 and the backlight control unit shown in FIG. 10 according to an embodiment of the present invention; and

FIG. 12 is a schematic diagram illustrating an example signal exchange between a transmitting and receiving control unit of the first control driver shown in FIG. 3 and the transmitting and receiving control unit of the second control driver shown in FIG. 8 according to an embodiment of the present invention.

### DETAILED DESCRIPTION

Embodiments of the present invention will be described in detail with reference to the accompanying drawings. The present invention, however, may be embodied in various different forms, and should not be construed as being limited only to the illustrated embodiments. Rather, these embodiments are provided as examples to more fully convey concepts of the present invention to those skilled in the art. Accordingly, known processes, elements, and techniques may not be described with respect to some of the embodiments. Unless otherwise noted, like reference numerals denote like elements throughout the attached drawings and written description, and thus descriptions may not be repeated. In the drawings, the sizes and relative sizes of layers and regions may be exaggerated for clarity.

It will be understood that, although the terms “first”, “second”, “third”, etc., may be used herein to describe various elements, components, regions, layers, and/or sections, these elements, components, regions, layers, and/or sections should not be limited by these terms. Rather, these terms are used primarily to distinguish one element, component, region, layer, or section from another element, component, region, layer, or section. Thus, in different embodiments, a first element, component, region, layer, or section discussed below could be termed a second element, component, region, layer, or section without departing from the teachings of the present invention.

Spatially relative terms, such as “beneath”, “below”, “lower”, “under”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below depending on perspective as would be apparent to one of ordinary skill. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is primarily for the purpose of describing particular embodiments and is not intended to be limiting of the present invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In addition, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or embodiments of the present invention and will not be interpreted in an idealized or overly formal sense unless expressly so defined herein.

Herein, the use of the term “may,” when describing embodiments of the present invention, refers to “one or more embodiments of the present invention.” In addition, the use of alternative language, such as “or,” when describing embodiments of the present invention, refers to “one or more embodiments of the present invention” for each corresponding item listed.

The display apparatus and/or any other relevant devices or components according to embodiments of the present invention described herein may be implemented utilizing any suitable hardware, firmware (e.g., an application-specific integrated circuit), software, or a suitable combination of software, firmware, and hardware. For example, the various components of the display apparatus may be formed on one integrated circuit (IC) chip or on separate IC chips. Further, the various components of the display apparatus may be implemented on a flexible printed circuit film, a tape carrier package (TCP), a printed circuit board (PCB), or formed on a same substrate as display apparatus.

Further, the various components of the display apparatus may be a process or thread, running on one or more processors, in one or more computing devices, executing computer program instructions and interacting with other system components for performing the various functionalities described herein. The computer program instructions are stored in a memory that may be implemented in a computing device using a standard memory device, such as, for example, a random access memory (RAM). The computer program instructions may also be stored in other non-transitory computer readable media such as, for example, a CD-ROM, flash drive, or the like. In addition, a person of skill in the art should recognize that the functionality of various computing devices may be combined or integrated into a single computing device, or the functionality of a particular computing device may be distributed across one or more other computing devices without departing from the scope of the present invention.

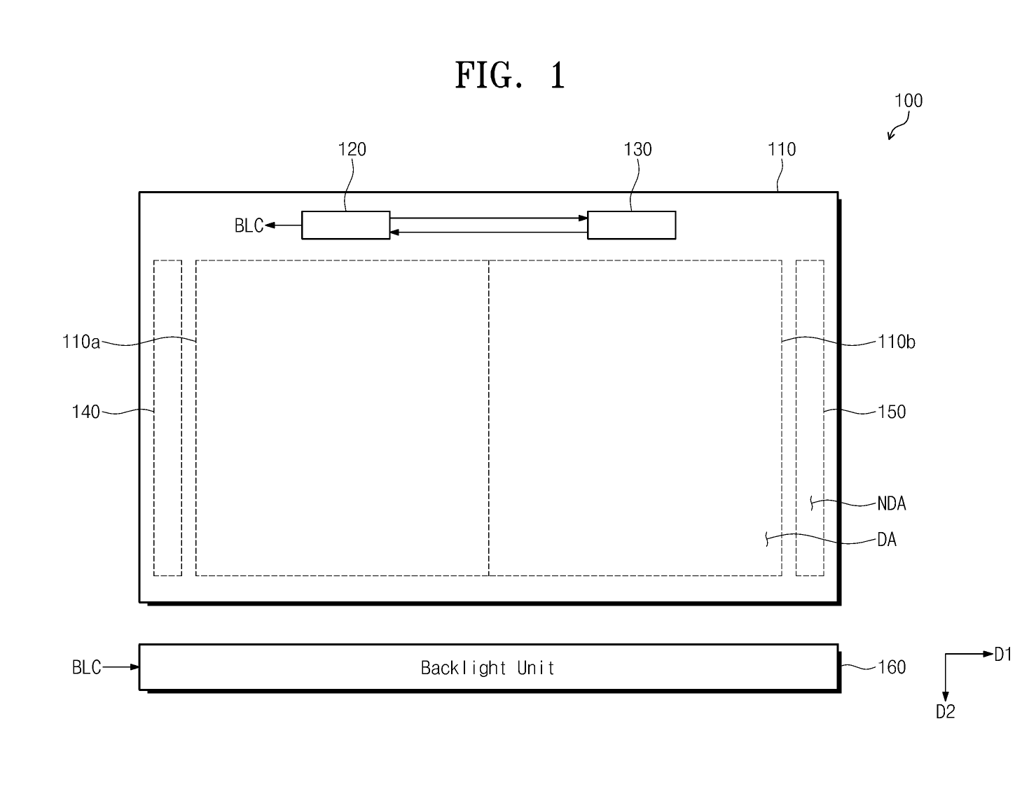

FIG. 1 is a schematic diagram illustrating a display apparatus 100 according to an embodiment of the present invention.

Referring to FIG. 1, the display apparatus 100 includes a display panel 110, a first control driver 120, a second control driver 130, a first gate driver 140, a second gate driver 150, and a backlight unit 160. The display apparatus 100 controls the amount of light emitted from the backlight unit 160 and displays images. For example, the display apparatus 100 may be a Liquid Crystal Display (LCD). The display panel 110 includes a display area DA and a non-display area NDA adjacent to the display area DA. The display area DA is a region where images are displayed. The non-display area NDA is a region where images are not displayed. The display panel 110 may be implemented, for example, using a glass substrate, a silicon substrate, or a film substrate.

The display area DA of the display panel 110 includes a first display area 110a and a second display area 110b. In an embodiment, the first display area 110a and the second display area 110b are parallel to a first direction D1, but the arrangement direction of the first display area 110a and the second display area 110b may vary in other embodiments. Further, in an embodiment, the display area DA is divided into two display areas 110a and 110b. However, the present invention is not limited thereto. For example, in other embodiments, the display area DA may be divided into three or more display areas.

The first control driver 120 and the second control driver 130 respectively correspond to the first display area 110a and the second display area 110b. In this example, the first control driver 120 is a master control driver and the second control driver 130 is a slave control driver. The first control driver 120 and the second control driver 130 are located in the non-display area NDA of the display panel 110 and electrically connected to data lines of the corresponding display areas 110a and 110b.

Based on (e.g., in response to) first data signals and first control signals inputted from an external device, the first control driver 120 controls the display panel 110 such that images are displayed on the first display area 110a. The second control driver 130 controls the display panel 110 based on (e.g., in response to) second data signals and second control signals inputted from the external device such that images are displayed on the second display area 110b. The first control signals include a first data enable signal and the second control signal a second data enable signal.

Signals are exchanged between the first control driver 120 and the second control driver 130. Signal exchange between the first control driver 120 and the second control driver 130 will be described later in further detail. The first control driver 120 generates a backlight control signal BLC for adjusting luminance of the backlight unit 160.

When the number of control drivers is three or more, one control driver is a master control driver and other control drivers are slave control drivers. The master control driver, for example, may be the only control driver that generates the backlight control signal BLC.

The first gate driver 140 and the second gate driver 150 may be implemented, for example, with a circuit using one or more of an amorphous silicon gate (ASG)—using an amorphous Silicon Thin Film Transistor (a-Si TFT)—an oxide semiconductor, a crystalloid semiconductor, and a polycrystalline semiconductor, and are fabricated or integrated in the non-display area NDA. The first gate driver 140 is arranged along one side of the first display area 110a, and the second gate driver 150 is arranged along one side of the second display area 110b. In another embodiment, each of the first gate driver 140 and the second gate driver 150 is part of an integrated circuit and they are connected to respective sides of the display panel 110.

The backlight unit 160 supplies light to the display panel 110. The backlight unit 160 may use, for example, a light emitting diode (LED) as a light source. The backlight unit 160 may adjust luminance of light based on (e.g., in response to) the backlight control signal BLC from the first control driver 120.

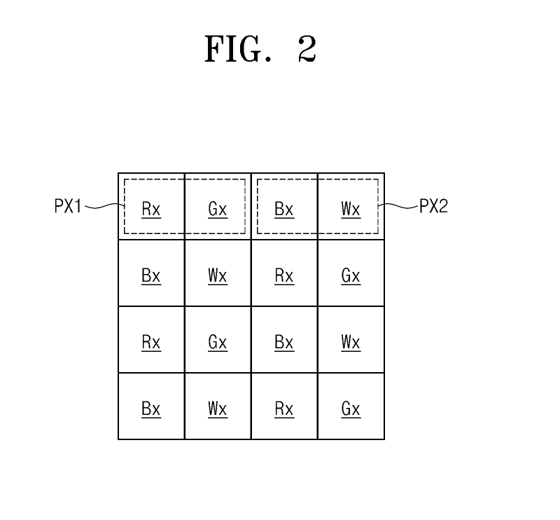

FIG. 2 is a schematic diagram illustrating an example array of pixels included in a display panel shown in FIG. 1 according to an embodiment of the present invention.

Referring to FIG. 2, the display panel 110 includes a first pixel PX1 and a second pixel PX2. The first pixel PX1 includes a first sub pixel Rx and a second sub pixel Gx. The second pixel PX2 includes a third sub pixel Bx and a fourth sub pixel Wx. The first pixel PX1 and the second pixel PX2 are arranged sequentially and alternately in the first direction D1 and in a second direction D2 crossing the first direction D1 (for example, perpendicular to the first direction D1).

While many embodiments discussed in the present specification are directed to a display panel 110 to which an RGBW sub pixel pattern is applied, other embodiments of the present invention may be similarly applied to a display panel to which other (e.g., RGBY, RGBC, CWYW, etc.) sub pixel patterns are applied

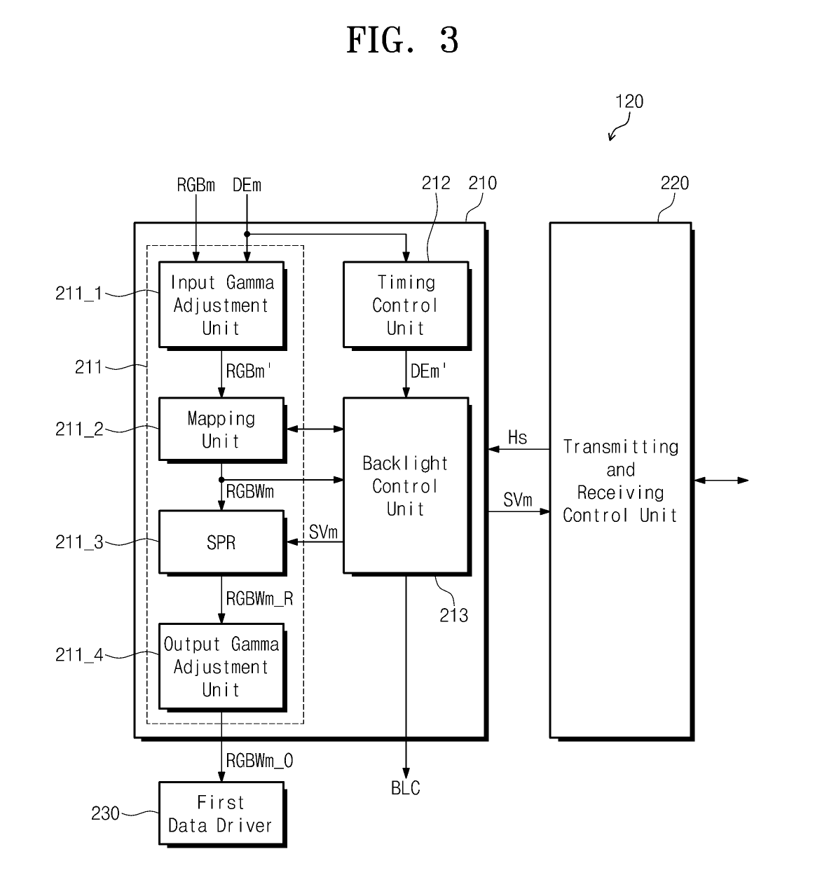

FIG. 3 is a block diagram illustrating an example configuration of the first control driver 120 shown in FIG. 1 according to an embodiment of the present invention.

Referring to FIG. 3, the first control driver 120 includes a first controller 210, a transmitting and receiving control unit 220, and a first data driver 230. The first control driver 120 may be implemented, for example, as a single integrated circuit. The first controller 210 outputs first output data signals RGBWm_O and a backlight control signal BLC based on (e.g., in response to) first data signals RGBm, a first data enable signal Dem (e.g., corresponding to the supplying of the first data signals RGBm), and a second histogram Hs (which is provided from the second control driver 130 shown in FIG. 1).

In further detail, the first controller 210 includes a rendering module 211, a timing control unit 212, and a backlight control unit 213. The rendering module 211 includes an input gamma adjustment unit 211_1, a mapping unit 2112, a sub pixel rendering unit 2113, and an output gamma adjustment unit 211_4.

The input gamma adjustment unit 211_1 receives the first data signals RGBm. The input gamma adjustment unit 211_1 outputs first gamma data signals RGBm′ that are linearized such that a gamma characteristic of the first data signals RGBm may be proportional to luminance, such as intended luminance. The first gamma data signals RGBm′ include red data R, green data G, and blue data B. The mapping unit 211_{—}2 maps the first gamma data signals RGBm′ to first middle data signals RGBWm including white data W as well as the red data R, the green data G, and the blue data B (e.g., the mapping unit 211_2 may convert some of the red data R, the green data G, and the blue data B from the first gamma data signals RGBm′ into a corresponding amount of the white data W in the first middle data signals RGBWm).

The sub pixel rendering unit 211_3 outputs first rendering signals RGBWm_R (e.g., data signals adjusted for the sub pixel pattern of the first display area 110a) based on (e.g., in response to) the first middle data signals RGBWm and a first scaler signal SVm from the backlight control unit 213. The output gamma adjustment unit 211_4 applies an inverse gamma function to the first rendering signals RGBWm_R and outputs the first output data signals RGBWm_O that are unlinearized (e.g., gamma corrected, such as proportional to perceived luminance). The first output data signals RGBWm_O are supplied to the first data driver 230.

The timing control unit 212 outputs a first enable signal DEm′ that is produced by controlling a timing of the first data enable signal DEm. The backlight control unit 213 generates the first scaler signal SVm and the backlight control signal BLC based on (e.g., in response to) the first enable signal DEm′, the first middle data signals RGBWm, and the second histogram Hs from the second control driver 130. The first scaler signal SVm is supplied to the output gamma adjustment unit 211_4. Further, the first scaler signal SVm is supplied to the second control driver 130 through the transmitting and receiving control unit 220.

The first data driver 230 transforms the first output data signals RGBWm_O from the first controller 210 into grayscale voltages and provides the grayscale voltages to the first display area 110a of the display panel 110 shown in FIG. 1. The transmitting and receiving control unit 220 controls signals transmitted and received between the first controller 210 and the second control driver 130.

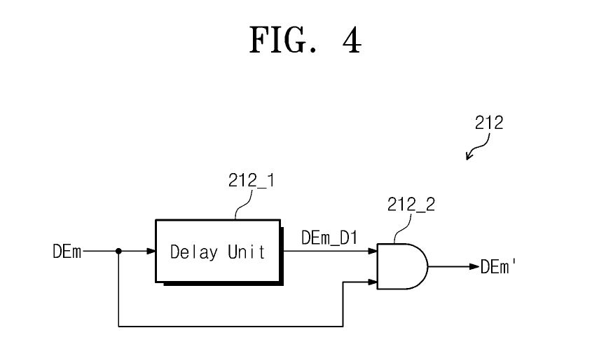

FIG. 4 is a circuit diagram illustrating an example configuration of the timing control unit 212 shown in FIG. 3 according to an embodiment of the present invention.

Referring to FIG. 4, the timing control unit 212 includes a delay unit 212_1 and a logic circuit 212_2. The delay unit 212_1 delays the first data enable signal DEm for a set or predetermined time (e.g., the time between consecutive first data signals RGBm, which may correspond to a shift register clock signal) and outputs a first delayed data enable signal DEm_D1. The logic circuit 212_2 performs a logic AND operation with respect to the first data enable signal DEm and the first delayed data enable signal DEm_D1, and outputs the first enable signal DEm′.

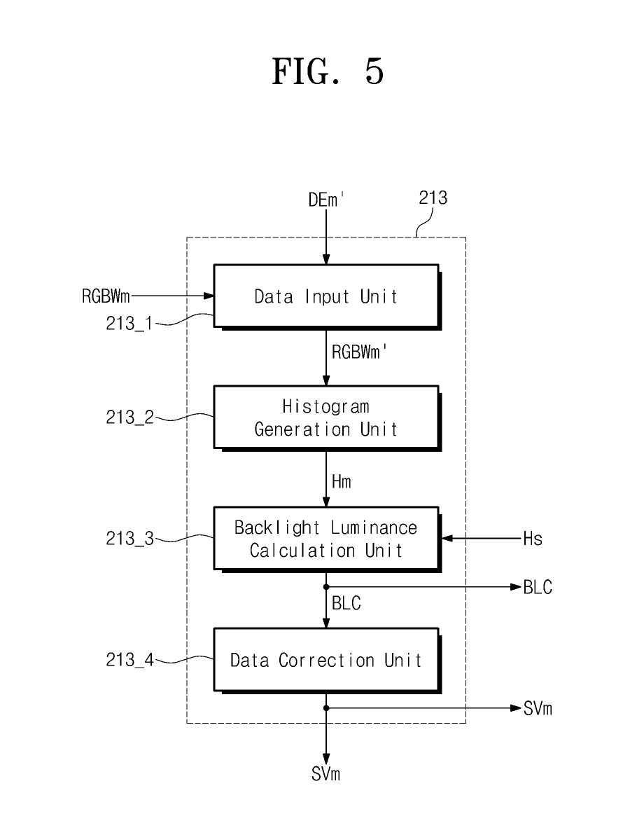

FIG. 5 is a block diagram illustrating an example configuration of the backlight control unit 213 shown in FIG. 3 according to an embodiment of the present invention.

Referring to FIG. 5, the backlight control unit 213 includes a data input unit 213_1, a histogram generation unit 213_2, a backlight luminance calculation unit 213_3, and a data correction unit 213_4. The data input unit 213_1 selects a portion (such as an initial portion) of the first middle data signals RGBWm from the mapping unit 211_2 shown in FIG. 3 based on (e.g., in response to) a first enable signal DEm′ from the timing control unit 212 shown in FIG. 3, and outputs first middle input data signals RGBWm′.

The histogram generation unit 213_2 generates a first histogram Hm corresponding to an image characteristic (e.g., luminance) of the first middle input data signals RGBWm′. For example, the first histogram Hm may be an accumulation or breakdown of luminance data of the first middle input data signals RGBWm′ accumulated during a frame.

The backlight luminance calculation unit 213_3 generates a backlight control signal BLC based on the first histogram Hm and a second histogram Hs from the second control driver 130 shown in FIG. 1. The backlight control signal BLC is supplied to the backlight unit 160 shown in FIG. 1. The data correction unit 213_4 generates a first scaler signal SVm (e.g., for correcting or adjusting data signals such as the first middle data signals RGBWm) corresponding to the backlight control signal BLC.

The backlight control unit 213 may, for example, adjust luminance of the backlight unit 160 based on the first middle data signals RGBWm which are outputted from the mapping unit 211_2 shown in FIG. 3. Further, the first scaler signal SVm, which is generated according to luminance adjustment of the backlight unit 160, is supplied to the sub pixel rendering unit 211_3 (e.g., for adjusting the first middle data signals RGBWm in accordance with the backlight control signal BLC). Because the sub pixel rendering unit 211_3 may perform a rendering operation based on the first scaler signal SVm as well as the first middle data signals RGBWm, image quality of the display panel 110 shown in FIG. 1 may be enhanced.

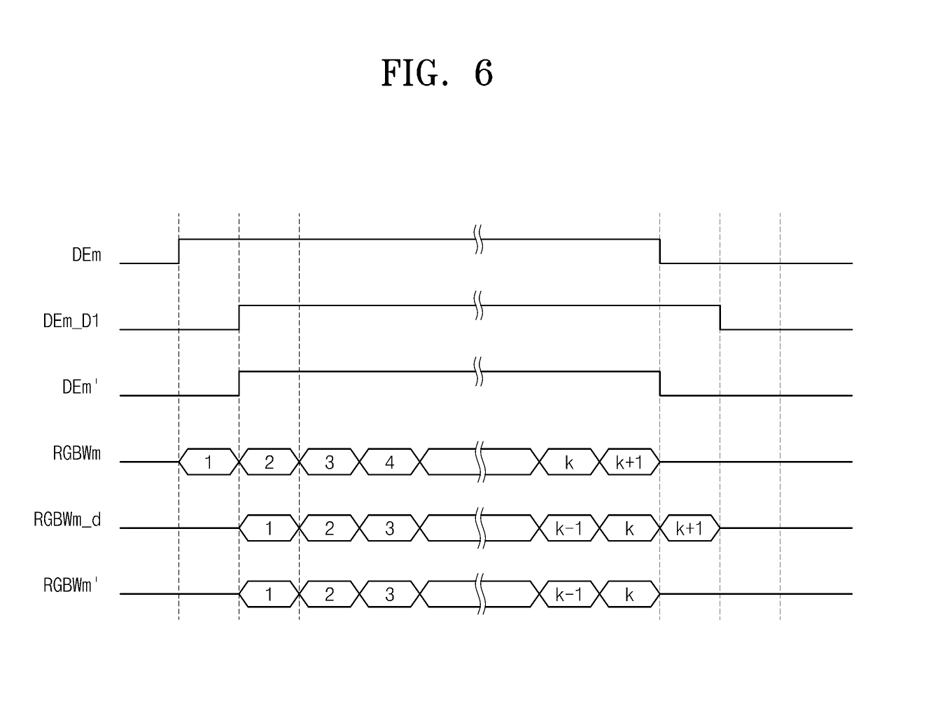

FIG. 6 is a timing diagram illustrating an example operation of the timing control unit shown 212 in FIG. 4 and the backlight control unit 213 shown in FIG. 5 according to an embodiment of the present invention.

Referring to FIGS. 4 to 6, the delay unit 212_1 outputs the first delayed data enable signal DEm_D1 that is produced by delaying the first data enable signal DEm for a set or predetermined time (e.g., corresponding to a clock signal input to a shift register). The first enable signal DEm′, which is outputted from the logic gate 212_2, remains in a high level when both the first data enable signal DEm and the first delayed data enable signal DEm_D1 are in the high level.

The first middle data signals RGBWm include a portion of the data signals of the second display area 110b as well as the data signals of the first display area 110a, which are in the display panel 110 shown in FIG. 1, according to operation characteristics of the sub pixel rendering unit 211_3 (e.g., some rendering of data signals for the first display area 110a may use data signals from a portion of the second display area 110b depending on factors such as the sub pixel configuration).

For example, it is assumed that the display panel 110 includes n pixel columns (n is a positive integer) in the first direction D1 and the first display area 110a includes k of those n pixel columns (k is a positive integer less than n, such as one half of n). Here, the first data signals RGBm may include data signals corresponding to the first to k-th pixel columns as well as the data signals corresponding to the (k+1)-th pixel column located in the second display area 110b. However, the backlight control unit 213 disregards these data signals corresponding to the (k+1)-th pixel column because they are not used by the backlight control unit 213 to determine the backlight control signal BLC or the first scaler signal SVm, correspond to the data signals of the first to k-th pixel columns.

In further detail, the backlight control unit 213 generates (e.g., in the data input unit 213_1) first delayed middle data signals RGBWm_d that are produced by delaying the first middle data signals RGBWm as long as a delay time of the delay unit 212_1, and outputs the first scaler signal SVm and the backlight control signal BLC using the first middle input signals RGBWm′ that are produced from the first delayed middle data signals RGBWm_d when the first enable signal DEm′ is in the high level.

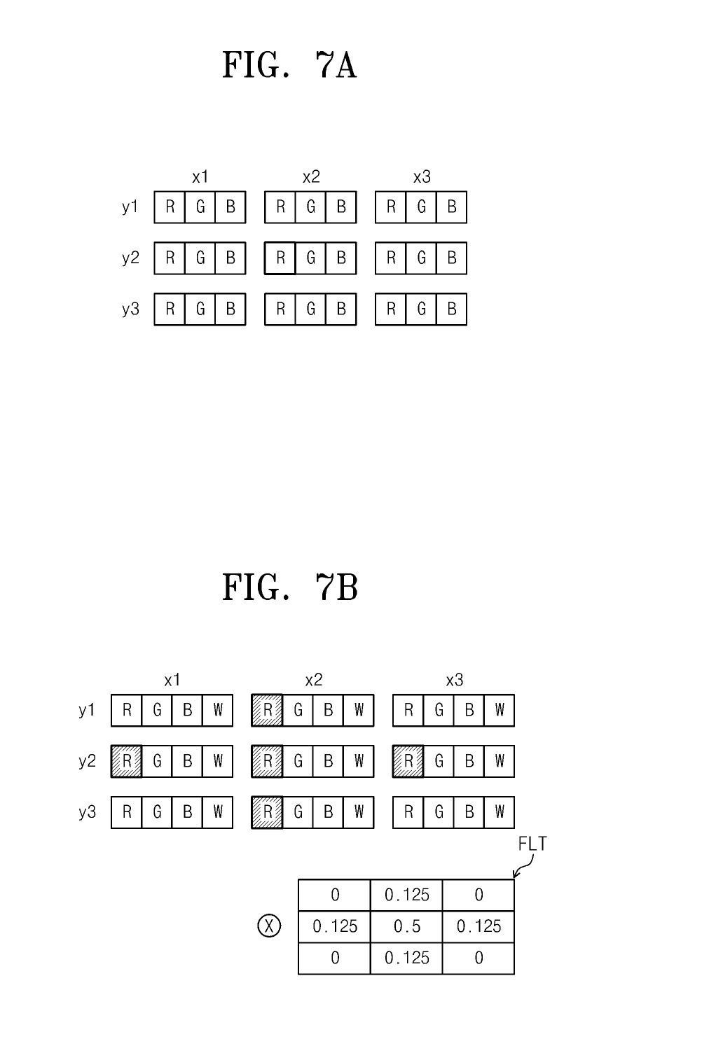

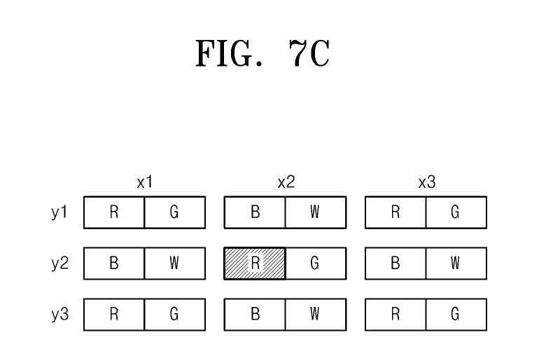

FIGS. 7A to 7C are schematic diagrams illustrating example mapping and rendering processes of the mapping unit 211_2 and the sub pixel rendering unit 211_3 shown in FIG. 3 according to embodiments of the present invention. FIG. 7A shows each pixel of a 3-sub-pixel structure using x-y coordinates. FIGS. 7B and 7C show structures that map x-y coordinates of 3-sub-pixel structures to a 4-sub-pixel structure and a 2-sub-pixel structure (in this case, a pentile pixel structure), respectively. Here, because the sub pixel rendering unit 211_3 adapts a diamond filter that uses 9 pixels (in a 3×3 arrangement), only 9 pixels are illustrated in FIGS. 7A to 7C as example embodiments.

Referring to FIGS. 3, 7A, and 7B, the mapping unit 211_{—}2 maps red, green, and blue data R, G, and B, which is supplied to each pixel, to red, green, blue, and white data R, G, B, and W.

Referring to FIGS. 3, 7B and 7C, the red, green, blue, and white data R, G, B, and W, which are outputted from the mapping unit 2112, are rendered using, for example, a diamond filter FLT included in the sub pixel rendering unit 211_3. For example, the red data R corresponding to a red sub pixel Rx of a pentile pixel structure may be generated by passing standard red data R included in the x2-y2 coordinate and the 8 red data R adjacent to the standard red data R through the diamond filter FLT.

As shown in FIG. 7B, scale coefficients respectively corresponding to 9 designated areas are stored in the diamond filter FLT. Moreover, the sub pixel rendering unit 211_3 may multiply 9 red data by the scale coefficients of corresponding locations and add the corresponding products to produce a rendering value of the standard red data R. Here, a summation of the scale coefficients that are included in the 9 designated positions is set to 1. In a similar method, green, blue, and white data may be rendered. Further, the sub pixel rendering unit 211_3 may change the scale coefficients corresponding to, for example, the 9 designated areas of the diamond filter FLT according to the first scaler signal SVm from the backlight control unit 213.

While FIG. 7B shows the diamond filter FLT as an embodiment of the present invention, other embodiments are not limited to the diamond filter FLT. That is, in other embodiments, other rendering filters may be used.

Because the red data of the xk−1 coordinate (e.g., (k−1)-th pixel column) and the xk−1 (e.g., (k−1)-th pixel column) red data is used to render the standard red data R of the xk coordinate (e.g., kth pixel column), the data signals corresponding to (k+1)-th pixel column, which is arranged in the second display area 110b, are also included in the first data signals RGBm. However, the data signals used to operate the backlight control unit 213 correspond to the first to k-th pixel columns. Accordingly, as described above with reference to FIGS. 5 and 6, the backlight control unit 213 generates the first scaler signal SVm and the backlight control signal BLC after removing the data signals corresponding to the (k+1)-th pixel column from the first data signals RGBm.

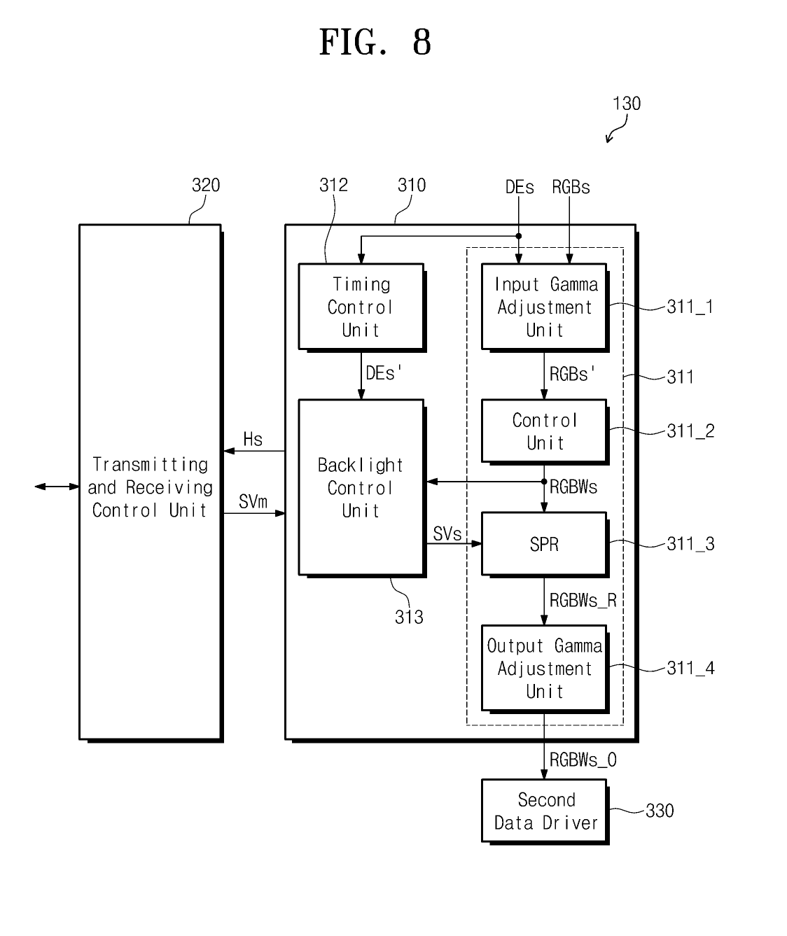

FIG. 8 is a block diagram illustrating an example configuration of the second control driver 130 shown in FIG. 1 according to an embodiment of the present invention.

Referring to FIG. 8, the second control driver 130 includes a second controller 310, a transmitting and receiving control unit 320, and a second data driver 330. The second control driver 130 may be implemented, for example, as a single integrated circuit. The second controller 310 outputs second output data signals RGBWs_O based on (e.g., in response to) second data signals RGBs, a second data enable signal DEs, and a first scaler signal SVm from the first control driver 120 shown in FIG. 1.

In further detail, the second controller 310 includes a rendering module 311, a timing control unit 312, and a backlight control unit 313. The rendering module 311 includes an input gamma adjustment unit 311_1, a mapping unit 3112, a sub pixel rendering unit 3113, and an output gamma adjustment unit 311_4.

The input gamma adjustment unit 311_1 receives the second data signals RGBs. The input gamma adjustment unit 311_1 outputs second gamma data signals RGBs' that are linearized such that a gamma characteristic of the second data signals RGBs may be proportional to luminance, such as intended luminance. The second gamma data signals RGBs' include red data R, green data G, and blue data B. The mapping unit 311_{—}2 maps the second gamma data signals RGBs' to second middle data signals RGBWs including white data W as well as the red data R, the green data G, and the blue data B (e.g., the mapping unit 311_2 may convert some of the red data R, the green data G, and the blue data B from the second gamma data signals RGBs' into a corresponding amount of the white data W in the second middle data signals RGBWs).

The sub pixel rendering unit 311_3 outputs second rendering signals RGBWs_R (e.g., data signals adjusted for the sub pixel pattern of the second display area 110b) based on (e.g., in response to) the second middle data signals RGBWs and a second scaler signal SVs from the backlight control unit 313. The output gamma adjustment unit 311_4 applies an inverse gamma function to the second rendering signals RGBWs_R and outputs the second output data signals RGBWs_O that are unlinearized (e.g., gamma corrected, such as proportional to perceived luminance). The second output data signals RGBWs_O are supplied to the second data driver 330.

The timing control unit 312 controls a timing of the second data enable signal DEs and outputs a second enable signal DEs′. The backlight control unit 313 generates the second scaler signal SVs based on (e.g., in response to) the second enable signal DEs′, the second middle data signals RGBWs, and the first scaler signal SVm from the first control driver 120.

The second data driver 330 transforms the second output data signals RGBWs_O from the second controller 310 into grayscale voltages and provides the grayscale voltages to the second display area 110b of the display panel 110 shown in FIG. 1. The transmitting and receiving control unit 320 controls signals exchanged between the second controller 310 and the first control driver 120.

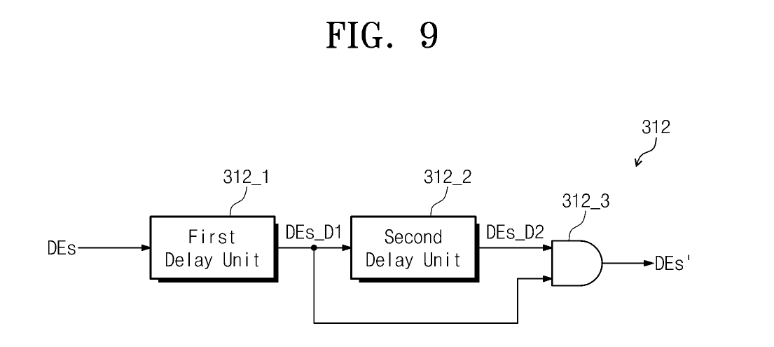

FIG. 9 is a circuit diagram illustrating an example configuration of the timing control unit 312 shown in FIG. 8 according to an embodiment of the present invention.

Referring to FIG. 9, the timing control unit 312 includes a first delay unit 312_1, a second delay unit 312_2, and a logic circuit 312_3. The first delay unit 312_1 delays the second data enable signal DEs for a set or predetermined time interval (e.g., the time between consecutive second data signals RGBs) and outputs a first delayed data enable signal DEs_D1. The second delay unit 312_2 delays the first delayed data enable signal DEs_D1 for a set or predetermined time and outputs the second delayed data enable signal DEs_D2. The logic circuit 312_3 performs a logic AND operation with respect to the first and second delayed data enable signals DEs_D1 and DEs_D2, and outputs a second enable signal DEs′.

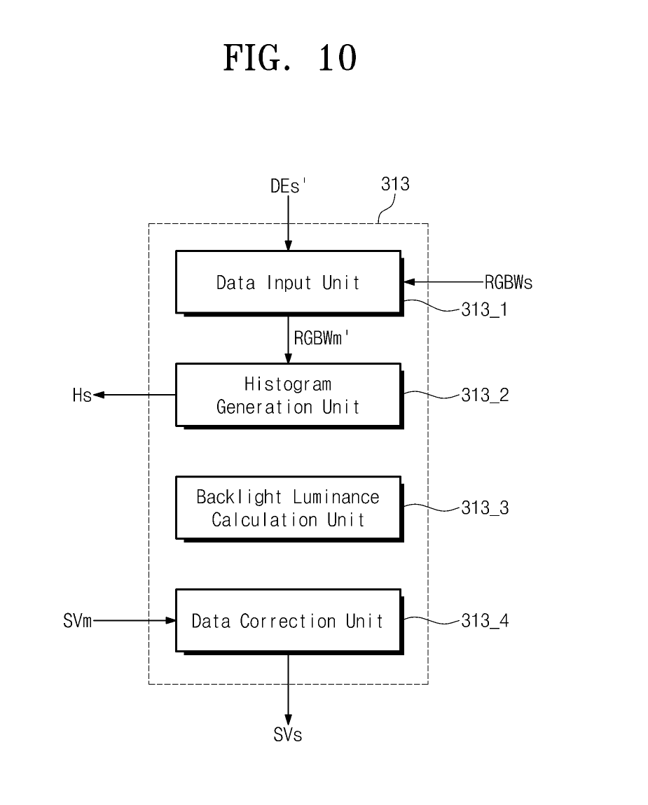

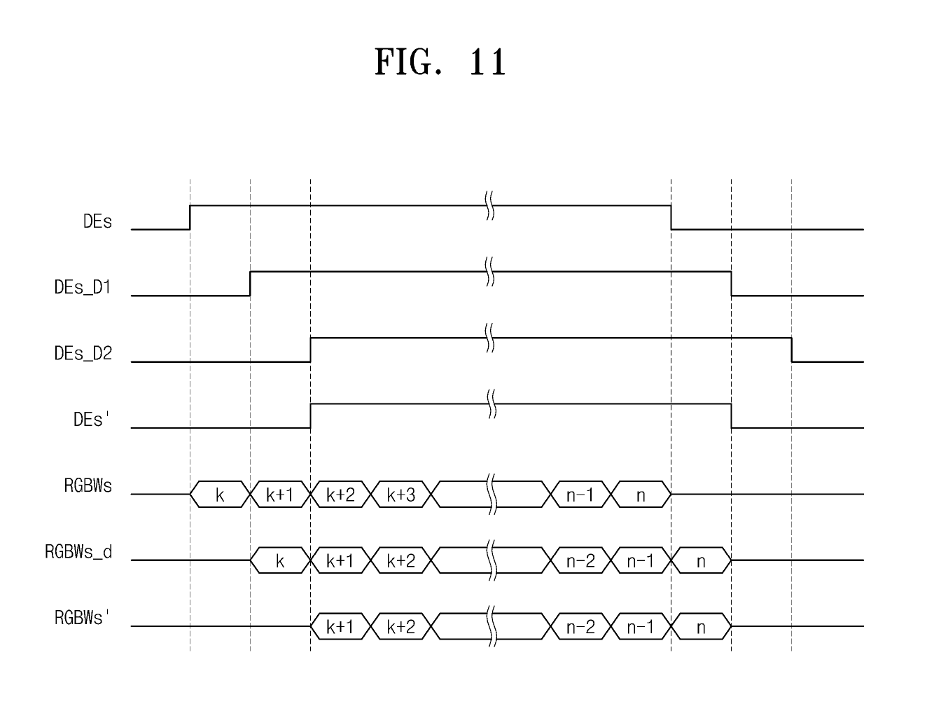

FIG. 10 is a block diagram illustrating an example configuration of the backlight control unit 313 shown in FIG. 8 according to an embodiment of the present invention.

Referring to FIGS. 8 and 10, the backlight control unit 313 includes a data input unit 313_1, a histogram generation unit 313_2, a backlight luminance calculation unit 313_3, and a data correction unit 313_4. The data input unit 313_1 selects a portion (such as a final portion) of the second middle data signals RGBWs from the mapping unit 311_2 based on (e.g., in response to) a second enable signal DEs' from the timing control unit 312 and outputs second middle input data signals RGBWs′.

The histogram generation unit 313_2 generates a second histogram Hs corresponding to an image characteristic (e.g., luminance) of the second middle input data signals RGBWs′. For example, the second histogram Hs may be an accumulation or breakdown of luminance data of the second middle input data signals RGBWs' accumulated during a frame.

Unlike the backlight luminance calculation unit 213_3, the backlight luminance calculation unit 3133 included in the second control driver 130, which is a slave control driver, may not substantially generate a backlight control signal BLC. Therefore, in some embodiments, the backlight control unit 313 may not include the backlight luminance calculation unit 313_3. However, the backlight control unit 313 may include the backlight luminance calculation unit 313_3 for production process efficiency of the control drivers (such as using the same control driver chip for the first control driver 120 and the second control driver 130).

The data correction unit 313_4 receives the first scaler signal SVm from the first control driver 120, which is a master control driver, shown in FIG. 3, and outputs the second scaler signal SVs. The second scaler signal SVs may be substantially equal to the first scaler signal SVm.

The backlight control unit 313 outputs the second scaler signal SVs based on (e.g., in response to) the first scaler signal SVm from the first control driver 120, which is a master control driver. The second scaler signal SVs is supplied to the sub pixel rendering unit 311_3. Because the sub pixel rendering unit 311_3 performs rendering based on the second scaler signal SVs as well as the second middle data signals RGBWs, image quality of the display panel 110 shown in FIG. 1 may be enhanced. Further, because the second scaler signal SVs may be substantially equal to the first scaler signal SVm, scale coefficients, which are used during rendering of the first control driver 120 and a second control driver 130, may be identical to each other. Accordingly, display quality of the first and second display areas 110a and 110b of the display panel 110 may remain identical.

FIG. 11 is a timing diagram illustrating an example operation of the timing control unit 312 shown in FIG. 9 and the backlight control unit 313 shown in FIG. 10 according to an embodiment of the present invention.

Referring to FIGS. 9 to 11, the first delay unit 312_1 outputs the first delayed data enable signal DEs_D1 that is obtained by delaying the second data enable signal DEs for a set or predetermined time. The second delay unit 312_2 outputs the second delayed data enable signal DEs_D2 that is produced by delaying the first delayed data enable signal DEs_D1 for a set or predetermined time. The second enable signal DEs′, which is outputted from the logic gate 3123, remains in the high level when both the first delayed data enable signal DEs_D1 and the second delayed data enable signal DEs_D2 are in the high level.

The second middle data signals RGBWs include a portion of the data signals of the first display area 110a as well as the data signals of the second display area 110b of the display panel 110 shown in FIG. 1 according to an operation characteristic of the sub pixel rendering unit 311_3 (e.g., some rendering of data signals for the second display area 110b may use data signals from a portion of the first display area 110a depending on factors such as the sub pixel configuration).

For example, it is assumed that the display panel 110 includes n pixel columns (n is a positive integer) in the first direction D1 and the second display area 110b includes n−k of those pixel columns (n−k is a positive integer less than n, such as one half of n), such as the (k+1)-th to n-th pixel columns. Here, the second data signals RGBs include data signals corresponding to the k-th pixel column that is located in the first display area 110a as well as data signals corresponding to the (k+1)-th to n-th pixel columns that are located in the second display area 110b. As described above, this may be due to a rendering operation of the sub pixel rendering unit 311_3 that operates in a similar manner to the sub pixel rendering unit 211_3 as described above with reference to FIGS. 7A to 7C.

However, the data signals corresponding to the k-th pixel column may need to be removed because the data signals used to operate the backlight control unit 313 correspond to the (k+1)-th to n-th pixel columns.

The data input unit 313_1 in the backlight control unit 313 outputs second delayed middle data signals RGBWs_d that are produced by delaying the second middle data signals RGBWs for as long a delay time of the first delay unit 312_1, and outputs the second delayed middle data signals RGBWS_d as the second middle input data signals RGBWs' when the second enable signal DEs' is in the high level. The second middle input data signals RGBWs' are supplied to the histogram generation unit 3132.

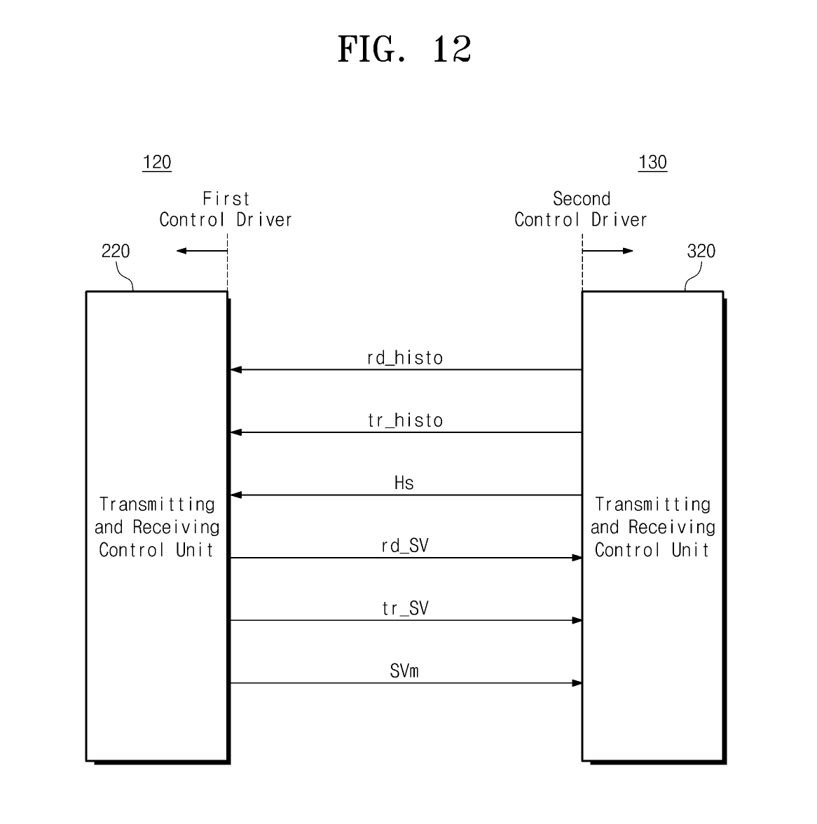

FIG. 12 is a schematic diagram illustrating an example signal exchange between the transmitting and receiving control unit 220 of the first control driver 120 shown in FIG. 3 and the transmitting and receiving control unit 320 of the second control driver 130 shown in FIG. 8 according to an embodiment of the present invention.

Referring to FIGS. 3, 8, and 12, the backlight control unit 313 in a second control driver 130 calculates a second histogram Hs. When calculation of the second histogram Hs ends, the transmitting and receiving control unit 320 of the second control driver 130 transmits a histogram transmission ready signal rd_histo to the transmitting and receiving control unit 220 of a first control driver 120 through the transmitting and receiving control unit 320. In addition, the transmitting and receiving control unit 320 of the second control driver 130 sets a histogram transmission flag tr_histo to the first level (e.g., ‘H’ level). When the histogram transmission flag tr_histo has the first level, the transmitting and receiving control unit 220 of the first control driver 120 receives the second histogram Hs from the transmitting and receiving control unit 320 of the second control driver 130.

The backlight control unit 213 in the first control driver 120 outputs the first scaler signal SVm. When the first scaler signal SVm is received, the transmitting and receiving control unit 220 of the first control driver 120 transmits a scaler transmission ready signal rd_sv to the transmitting and receiving control unit 320 of the second control driver 130. In addition, the transmitting and receiving control unit 220 of the first control driver 120 sets a scaler transmission flag tr_sv to the first level (e.g., ‘H’ level). The transmitting and receiving control unit 320 of the second control driver 130 receives the first scaler signal SVm from the transmitting and receiving control unit 220 of the first control driver 120 based on (e.g., in response to) the scaler transmission flag tr_sv.

The display apparatus 100 shown in FIG. 1 includes the first control driver 120 and the second control driver 130 respectively corresponding to the first display area 110a and the second display area 110b. The data lines included in the display panel 110 may be driven by at least two control drivers (e.g., the first control driver 120 and the second control driver 130).

In particular, if the display panel 110 includes pixels of a pentile configuration, each of the first control driver 120 and the second control driver 130 performs a rendering function for improving luminance of images. Here, the first control driver 120, which is a master control driver, generates a backlight control signal BLC and the first scaler signal SVm, based on the second histogram Hs from the second control driver 130, a slave control driver. Further, the second control driver 130 generates the second scaler signal SVs corresponding to the first scaler signal SVm.

Because histograms of the control drivers 120 and 130 may be shared by exchanging signals among the control drivers 120 and 130, image quality of the display panel 110 may be enhanced.

While the present invention has been described with reference to example embodiments, it will be apparent to those skilled in the art that various changes and modifications may be made without departing from the spirit and scope of the present invention. Therefore, it should be understood that the above embodiments are not limiting, but illustrative. and that the present invention is intended to cover various modifications and equivalent arrangements included within the spirit and scope of the appended claims, and equivalents thereof.

What is claimed is:

1. A display apparatus comprising:
a display panel including a first display area and a second display area;
a first control driver configured to receive first data signals, control the display panel to display images on the first display area, and generate a first histogram corresponding to the first data signals;
a second control driver configured to receive second data signals, control the display panel to display images on the second display area, and generate a second histogram corresponding to the second data signals; and
a backlight unit configured to supply light to the display panel,
wherein the first control driver is further configured to receive the second histogram from the second control driver and generate a backlight control signal for controlling luminance of the backlight unit based on the first and second histograms.

2. The display apparatus according to claim 1, wherein the first and second data signals each include first color data, second color data, and third color data.

3. The display apparatus according to claim 2, wherein the first control driver comprises:
a first controller configured to generate first output data signals based on the first data signals, a first data enable signal, and the second histogram, and to generate the backlight control signal;
a first data driver configured to drive the first display area of the display panel using the first output data signals; and
a first transmitting and receiving control unit configured to control a signal exchange between the first controller and the second control driver.

4. The display apparatus according to claim 3, wherein the first controller comprises:
a first rendering module configured to generate first middle data signals including the first color data, the second color data, the third color data, and a fourth color data based on the first data signals;
a first timing control unit configured to control a timing of the first data enable signal to output a first enable signal; and
a first backlight control unit configured to generate a first scaler signal and the backlight control signal based on the first enable signal, the first middle data signals, and the second histogram,
wherein the first rendering module is further configured to generate the first output data signals based on the first data signals and the first scaler signal.

5. The display apparatus according to claim 4, wherein the first backlight control unit comprises:
a first data input unit configured to output first middle input data signals by selecting a portion of the first middle data signals based on the first enable signal;
a first histogram generation unit configured to generate the first histogram corresponding to the first middle input data signals;
a backlight luminance calculation unit configured to generate the backlight control signal based on the first histogram and the second histogram from the second control driver; and
a first data correction unit configured to generate the first scaler signal corresponding to the backlight control signal.

6. The display apparatus according to claim 4, wherein the first transmitting and receiving control unit is further configured to supply the first scaler signal to the second control driver.

7. The display apparatus according to claim 4, wherein the first transmitting and receiving control unit is further configured to receive the second histogram from the second control driver when a histogram ready signal and a histogram transmission signal are received from the second control driver.

8. The display apparatus according to claim 4, wherein the first timing control unit comprises:
a delay unit configured to delay the first data enable signal for a first delay period; and
a logic circuit configured to perform a logical operation with respect to the first data enable signal and the delayed first data enable signal outputted from the delay unit to output the first enable signal.

9. The display apparatus according to claim 4, wherein the second control driver comprises:
a second controller configured to generate second output data signals based on the second data signals, a second data enable signal, and the first scaler signal;
a second data driver configured to drive the second display area of the display panel using the second output data signals; and
a second transmitting and receiving control unit configured to control a signal exchange between the second controller and the first control driver.

10. The display apparatus according to claim 9, wherein the second controller comprises:
a second rendering module configured to generate second middle data signals including the first color data, the second color data, the third color data, and the fourth color data based on the second data signals;
a second timing control unit configured to control a timing of the second data enable signal to output a second enable signal; and
a second backlight control unit configured to generate a second scaler signal based on the first scaler signal from the first control driver,
wherein the second rendering module is further configured to generate the second output data signals based on the second data signals and the second scaler signal.

11. The display apparatus according to claim 10, wherein the second timing control unit comprises:
a first delay unit configured to output a first delay signal by delaying the second data enable signal for a second delay period;
a second delay unit configured to output a second delay signal by delaying the first delay signal for a third delay period; and
a logic circuit configured to perform a logical operation with respect to the first delay signal and the second delay signal to output the second enable signal.

12. The display apparatus according to claim 11, wherein the second backlight control unit comprises:
a second data input unit configured to output second middle input data signals by selecting a portion of the second middle data signals based on the second enable signal;
a second histogram generation unit configured to generate the second histogram corresponding to the second middle input data signals; and
a second data correction unit configured to generate the second scaler signal based on the first scaler signal from the first control driver.

13. The display apparatus according to claim 9, wherein the second transmitting and receiving control unit is further configured to receive the first scaler signal from the first control driver when a scaler ready signal and a scaler transmission signal are received from the first control driver.

14. The display apparatus according to claim 4, wherein the first rendering module comprises:
an input gamma adjustment unit configured to adjust a gamma characteristic of the first data signals;
a mapping unit configured to map the first data signals to the first middle data signals;
a rendering unit configured to output first rendering signals by making the first middle data signals pass through a rendering filter; and
an output gamma adjustment unit configured to adjust a gamma characteristic of the first rendering signals to output the first output data signals.

15. The display apparatus according to claim 4, wherein
the display panel comprises first and second pixels,
the first pixel comprises first and second sub pixels respectively corresponding to the first color data and the second color data, and
the second pixel comprises third and fourth sub pixels respectively corresponding to the third color data and the fourth color data.

16. The display apparatus according to claim 1, wherein the first control driver is a master control driver and the second control driver is a slave control driver.
